(19) United States
(12) Patent Application Publication
(10) Pub. No.: US 2020/0274378 A1
(43) Pub. Date: Aug. 27, 2020

(54) VAPE CHARGING CASE

(71) Applicant: Charlotte Cuttita, Littleton, CO (US)

(72) Inventor: Charlotte Cuttita, Littleton, CO (US)

(21) Appl. No.: 16/286,076

(22) Filed: Feb. 26, 2019

(51) Int. Cl. H02J 7/00; A24F 47/00

(52) U.S. Cl. CPC H02J 7/0045; H02J 2007/0062; H02J 7/0054; A24F 47/008

(57) ABSTRACT

A vaping charger for charging or maintaining a charge for a vape pen is presented. The vaping charger has a case for storing a vaping pen. The case has a first side, a second side, a top lip, a top side, a bottom side, a hinged side, a top cavity and a bottom cavity. The hinged side having at least one strap for holding accessories. The bottom cavity has a vape pen holder for securely coupling the vape pen to the bottom cavity of the case. The case has a power switch coupled to the second side of the bottom side and coupled to a charging connector configured in the bottom cavity of the case. The case may have a clip for holding money or credit cards coupled to the top cavity substantially near the top lip. Further, the top cavity and the bottom cavity may be lined with a felt to protect the vape pen from damage while being stored. The case may also have a lock which securely couples the top side and the bottom side.

### FIELD OF THE INVENTION

This invention relates to vaping devices. More particularly, it relates to charging vaping devices.

### BACKGROUND

Electronic cigarettes, also known as e-cigarette (eCigs) and personal vaporizers (PVs), are electronic inhalers that vaporize or atomize a liquid solution into an aerosol mist that may then be delivered to a user.

A typical eCig has two main parts--a power supply portion and a atomizer/liquid reservoir portion. The power supply portion typically includes a rechargeable lithium-ion (Li-ion) battery, a light emitting diode (LED), and a pressure sensor. The atomizer/liquid reservoir portion typically includes a liquid solution, an atomizer, and a mouthpiece. The atomizer typically includes a heating coil that vaporizes the liquid solution.

The heating coil that vaporizes the liquid solution requires a power supply. The power supply needs to be charged such that the vaping device is available whenever the user desires to use it.

### BRIEF DESCRIPTION OF THE DRAWINGS

FIG. 1 is an illustrated view of an exemplary vape charger.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

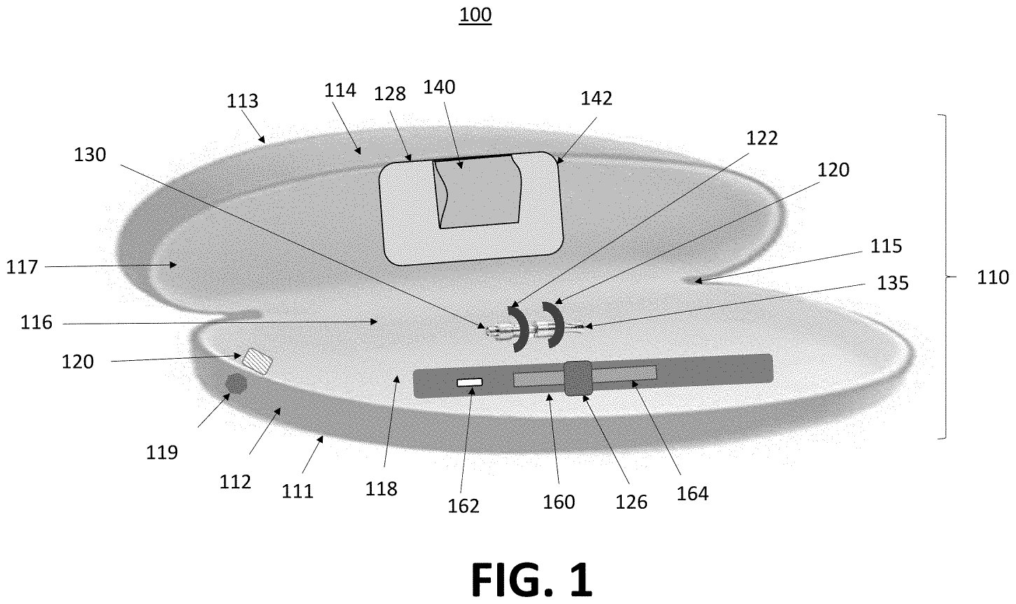

Referring to FIG. 1, an vape charger 100 is illustrated. The vape charger 100 is useful for having a secure, dirt free container for charging and/or maintaining a charge of a vaping device.

The vape charger 100 has a case 110, a vaping pen 160. The vape charger 100 may be any color. Further, the case 110 of the vape charger 100 is preferably claim shell shaped, but may be of any shape that can accommodate a vaping pen 160. Further, the case 110 is preferably seven (7) inches in length but may be other lengths that may comfortably fit the vaping pen 160.

The case 110 has a bottom side 111, a first side 112, a second side 113, a top side 114, a bottom cavity 118, a top cavity 117, a inset 115, and a hinged side 116. The bottom cavity 118 and the top cavity 117 provide a void space to store items such as the vaping pen 160, a vaping liquid cartridge 130, a reserve power source 135, etc.

The bottom cavity 118 and top cavity 117 generally have an inner covering which protects the vaping pen 160 from scratches and/or other damage. The bottom cavity and the top cavity 117 may be covered with felt, or other material which protects the vape pen 160 from damage.

The case 110 may be made out of any material but is preferably a hard plastic such that the contents are protected from environmental elements and from damage from dropping the case 110. Further, optionally a lock (not shown) may be located on the case 110 to protect the contents of the case 110 when the owner or user is not in the immediate vicinity.

The first side 112 of the case 110 has an on/off switch 113. The power switch 119 on the first side 112 of the case 110 is useful for turning on and off a charging of the vaping pen 160.

The first side 112of the bottom side 111 of the case 110 is securely coupled, when the case 110 is closed, to the second side 113 of the top side 114 of the case 110. When the case 110 is opened, the hinged side 116 releases to allow the first side 112 of the bottom side 111 of the case 110 to be at least partially displaced from the second side 113 of the top side 114 of the case 110.

The hinged side 116 does not release the bottom side 111 and the top side 114 therefore keeping the bottom side 111 and the top side 114 securely coupled. When opened, the case 110 looks similar to a clam that has been opened thus the name claim shell. The inset 115 of the case 110 is located on the hinged side 116 of the case 110, where the case 110 can be easily opened and closed.

The power switch 119 is coupled to a power connector 120. The power connector 120 is located inside the bottom cavity 118 of the case 110. The power connector 120 is preferably a micro USB cable but may also be a universal ego USB vaporizer vape pen charger cable 510 thread, or other power connector cable.

The hinged side 116 has at least one holder 122, 124. The at least one holder 122, 124 may securely hold the vaping liquid cartridge, the reserve power source 130, or more than one of the vaping liquid cartridge 135 and the reserve power source 130.

The bottom cavity 118 has a vape pen holder 126. The vape pen holder 126 is useful for storing securely the vape pen 160 inside of the case 160. The vape pen holder 126 may be an elastic material, may be Velcro secured or may be any type of material and latching material.

The vape pen 160 has a power control 162 and a cartridge insertion opening 164. The power control 162 of the vape pen 160 controls the power provided to the vape pen 160 and thus must be set in the on position for the vape pen 160 to be used. The cartridge insertion opening 164 of the vape pen 160 allows for the insertion of a vaping liquid cartridge 135 into the vaping pen 160 such that the user would have a source of liquid to be vaporized while inhaling the vapor.

The case 110 has a top lip 128. The top lip 128 is positioned where the second side 113 of the top side 114 meets with the top cavity 117. Optionally and or additionally, the case 110 has a clip 140. The clip 140 is coupled to the top cavity 117 substantially near the top lip 128. The clip 140 is preferably made of plastic, but may be made of aluminum, steel, etc. The clip 140 may hold one or more items 142. The one or more items 142 may be credit cards, identification cards, folding money, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A vaping charger, the vaping charger comprising:
a case, the case for storing a vaping pen, the case having a first side, a second side, a top lip, a top side, a bottom side, a hinged side, a top cavity and a bottom cavity;
the hinged side having at least one strap, the strap for holding accessories;
the bottom cavity having a vape pen holder, the vape pen holder for securely coupling the vape pen to the bottom cavity of the case;
a power switch, the power switch coupled to the second side of the bottom side and coupled to a charging connector configured in the bottom cavity of the case.

2. The vaping charger of claim 1, further comprising:
a clip, the clip coupled to the top cavity of the case substantially near the top lip; and
the clip containing one or more items.

3. The vaping charger of claim 2, wherein the item contained in the clip being folding money.

4. The vaping charger of claim 2, wherein the item contained in the clip being credit cards.

5. The vaping charger of claim 1, wherein the top cavity being a felt material.

6. The vaping charger of claim 1, wherein the top cavity being a felt material.

7. The vaping charger of claim 1, wherein the charging connector being a universal ego USB vaporizer vape pen charger cable 510 thread.

8. The vaping charger of claim 1, wherein the charging connector being a USB cable.

9. The vaping charger of claim 1, wherein the item contained in the clip being folding money.

10. The vaping charger of claim 1, wherein the item contained in the clip being folding money.

11. The vaping charger of claim 1, wherein the case being seven (7) inches in length.

12. The vaping charger of claim 1, wherein the accessory is a vaping liquid cartridge.

13. The vaping charger of claim 1, wherein the accessory is a reserve power source.

14. The vaping charger of claim 2, wherein the item contained in the clip being folding money.

15. The vaping charger of claim 1, further comprising:
A lock, the lock securely coupling the top side and the bottom side.
